(19) United States
(12) Patent Application Publication
(10) Pub. No.: US 2004/0252649 A1
(43) Pub. Date: Dec. 16, 2004

(54) Dual mode wireless network card link parameter setting device and method of the same

(76) Inventor: Wen Huiang Wu, Tau Yuan Hsien (TW)

Correspondence Address: Wen Huiang Wu, 235 Chung-Ho, P.O. Box 10-69, Taipei, TW

(21) Appl. No.: 10/457,708

(22) Filed: Jun. 10, 2003

(51) Int. Cl. H04L 12/28

(52) U.S. Cl. 370/254; 370/310

(57) ABSTRACT

A dual mode wireless network card link parameter setting device has communication protocol device connected to a wireless network card driver. The wireless network card driver includes a GPRS module and a wireless network 802.11 protocol module. The GPRS module serves for performing the interaction of the PPP procedure module of the GPRS module and the wireless network 802.11 protocol module so that the wireless network card driver is communicated with external devices. The PPP procedure module transfers signals to a GPRS communication end through the UART data poll module. The wireless network 802.11 protocol module is interacted with the PPP procedure module so that the wireless network card driver communicates with external devices, Thus, signals of the wireless network 802.11 protocol module is sent to a wireless network physical layer device.

### BACKGROUND OF THE INVENTION

1. Field of the Invention

The present invention relates to network devices, and particularly to a dual mode wireless network card link parameter setting device.

2. Description of the Related Art

With the development of wireless network, the wireless manufacturers have deeply understand that the convenience of wireless systems are important in design the wireless cylindrical main body. In the prior art, modems and network cards are used to network. The process is tedious and not user-friendly. In general, if a network card is inserted into a computer, the register code of the card is loaded into the computer and the computer identifies the codes. Then the computer can actuate a driving program for communicating with the network card. The same process is performed for modems. However, in this process, the user must check the hardware components to determine whether the insertion device is a modem or a network card and thus the operation is tedious.

Therefore, there has a demand for a dual mode wireless network card link parameter setting device and method of the same so as to resolve the inconvenience in the prior art.

### SUMMARY OF THE INVENTION

Accordingly, the primary object of the present invention is to provide a dual mode wireless network card link parameter setting device having a communication protocol device connected to a wireless network card driver. The wireless network card driver includes a GPRS module and a wireless network 802.11 protocol module. The GPRS module serves for performing the interaction of the PPP procedure module of the GPRS module and the wireless network 802.11 protocol module so that the wireless network card driver is communicated with external devices. The PPP procedure module transfers signals to a GPRS communication end through the UART data poll module. The wireless network 802.11 protocol module is interacted with the PPP procedure module so that the wireless network card driver communicates with external devices. Thus, signals of the wireless network 802.11 protocol module is sent to a wireless network physical layer device.

The various objects and advantages of the present invention will be more readily understood from the following detailed description when read in conjunction with the appended drawing.

### BRIEF DESCRIPTION OF THE DRAWINGS

FIG. 1 shows the structure of the present invention.

FIG. 2 shows the operation process of the present invention.

FIG. 3 shows another process of the present invention.

FIG. 4 shows one embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

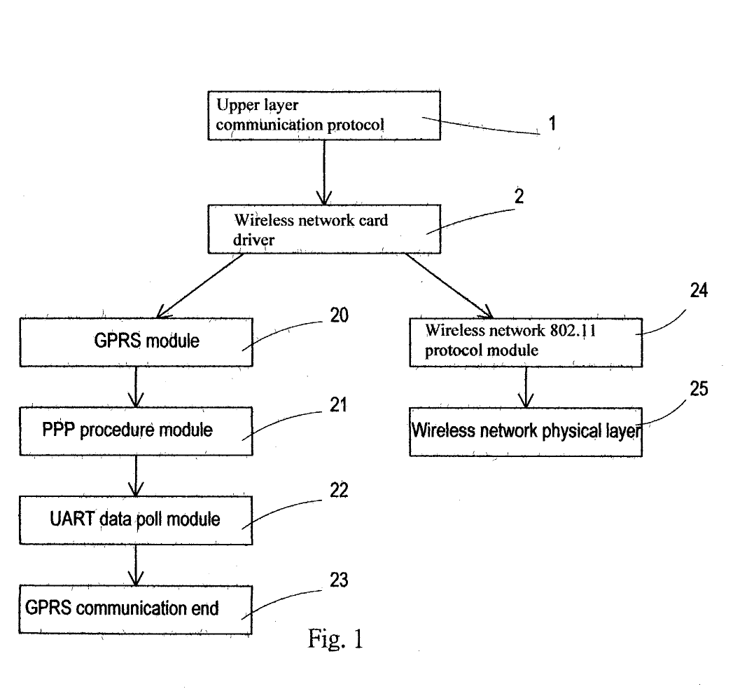

Referring to FIG. 1, the dual mode wireless network card link parameter setting device of the present invention is presented. In the present invention, the upper communication protocol device 1 is connected to a wireless network card driver 2. The wireless network card driver 2 includes a GPRS module 20 and a wireless network 802.11 protocol module 24. The wireless network card driver 2 includes the following components.

A GPRS module 20 serves for performing the interaction of the PPP procedure module 21 of the GPRS module 20 and the wireless network 802.11 protocol module 24 so that the wireless network card driver 2 can communicated with external devices. The PPP procedure module 21 transfers signals to a GPRS communication end 23 through the UART data poll module 22.

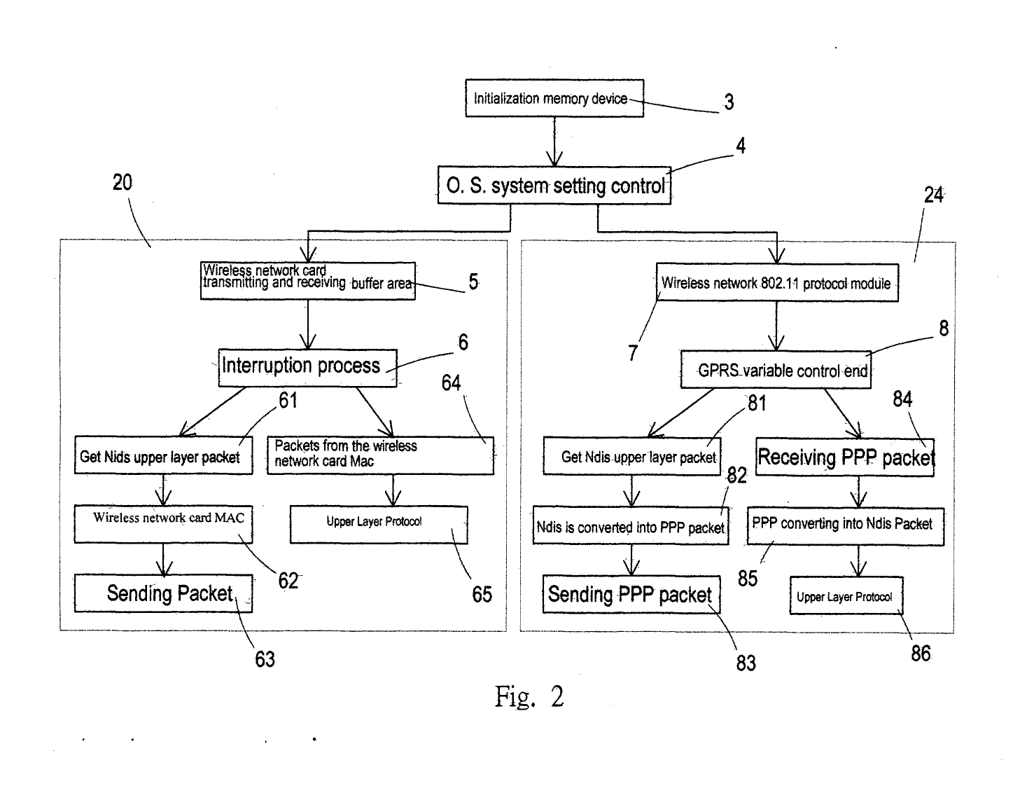

The wireless network 802.11 protocol module 24 is interacted with the PPP procedure module 21 so that the wireless network card driver 2 can communicate with external devices. Thus signals of the wireless network 802.11 protocol module 24 can be sent to a wireless network physical layer device 25. With reference to FIG. 2, in the dual mode operation, a module initial memory device 3 generates an operation system initialization setting control end 4. The operation system initialization setting control end 4 includes a wireless network card transmitting and receiving buffer area 5 and a GPRS data communication poll sequence 7,

The operation of the operation system initialization setting control end 4 includes the following steps of: performing a system interruption process (step 6) by the wireless network card transmitting and receiving buffer area 5 for getting Ndis upper layer packets (step 61) and getting packets from the wireless network card MAC (step 64); Sending packets of the Ndis upper layer packets to a wireless network card MAC, (step 62) and then transferring the packet (step 63); sending packets from the wireless network card MAC to the upper layer protocol device (step 65).

The GPRS data communication poll sequence comprises the following steps of: getting Ndis upper layer packets (step 81) and PPP packets (step 84) through a GPRS variable control end 8; converting the Ndis upper layer packets into PPP packets (step 82) and then sending the converting packets (step 83); converting the PPP packets into Ndis packets (step 85) and then sending the converted PPP packets into upper 1 packets matching layer protocol (step 86).

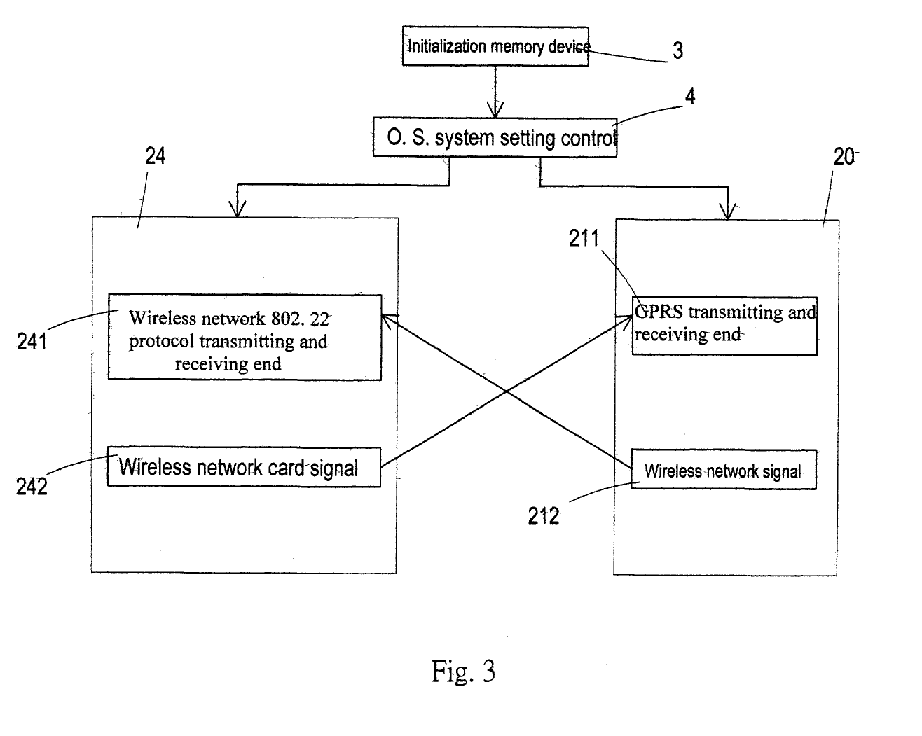

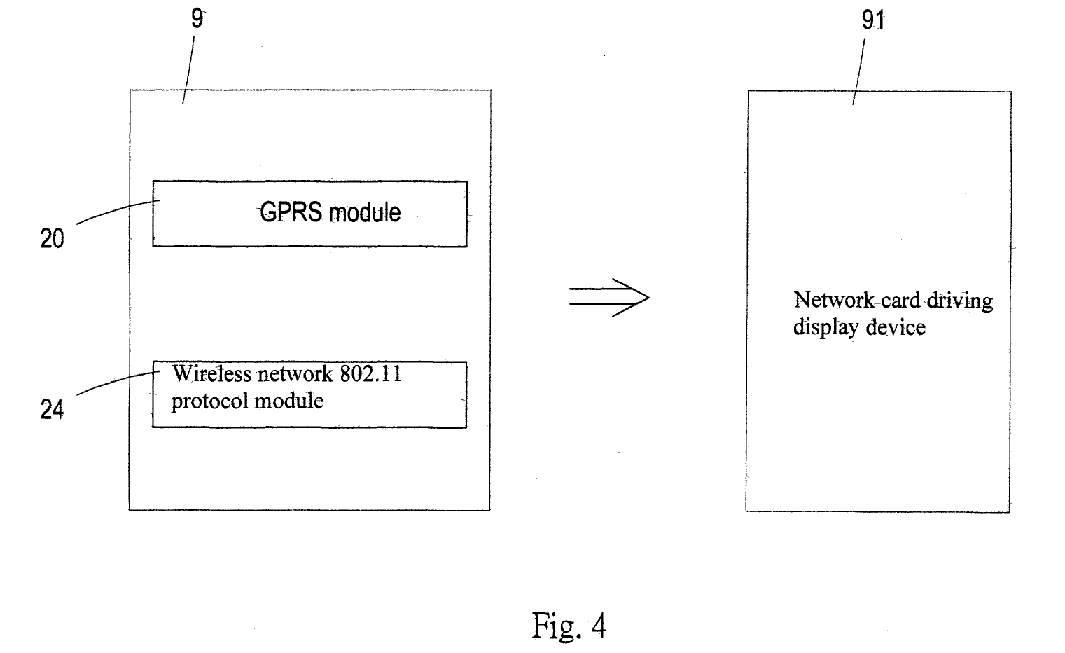

With reference to FIGS. 3 and 4, in the present invention, the control end of the wireless network card 9 only has one network card driving device 91 which generates interacting detecting signals. When the GPRS module 20 is actuated, a GPRS module transmitting and receiving end 211 serves to control the sending and transmitting of the signals and detect the wireless network card signals 212. When actuating the wireless network 802.11 protocol module 24, transmitting and receiving ends 241, of the wireless network 802.11 protocol module 24 serves to control the transmitting and receiving of signals and detecting wireless network card signals so as to perform a dual mode operation.

Thereby, in the present invention, a wireless network card has a dual mode driver and only one driving device. One wireless network card provides a driving program which can be used both in a GPRS module and a wireless network 802.11 protocol module. Only one driving program is used and thus it is convenient in use.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A dual mode wireless network card link parameter setting device having a communication protocol device connected to a wireless network card driver; the wireless network card driver including
a GPRS module and
a wireless network 802.11 protocol module;
wherein the GPRS module serves for performing the interaction of the PPP procedure module of the GPRS module and the wireless network 802.11 protocol module so that the wireless network card driver is communicated with external devices; the PPP procedure module transfers signals to an GPRS communication end through a UART data poll module,
the wireless network 802.11 protocol module is interacted with the PPP procedure module so that the wireless network card driver communicates with external devices; thus signals of the wireless network 802.11 protocol module are sent to a wireless network physical layer device.

2. A dual mode wireless network card link parameter setting method using a dual mode operation wherein a module initial memory device generates an operation system initialization setting control end; the operation system initialization setting control end includes a wireless network card transmitting and receiving buffer area and a GPRS data communication poll sequence; the method comprising the step of:
performing a system interruption process by the wireless network, card transmitting and receiving buffer area for getting Ndis upper layer packets
getting packets from the wireless network card MAC;
sending packets of the Ndis upper layer packets to a wireless network card MAC;
sending packets from the wireless network card MAC to the upper layer protocol device;

3. The method of claim 2, wherein the GPRS data communication poll sequence comprises the following steps of:
getting Ndis upper layer packets and PPP packets through the GPRS variable control end;
converting the Ndis upper layer packets into PPP packets;
sending the converting PPP packets;
converting the PPP packets into Ndis packets; and
sending the converted PPP packets into upper packets matching layer protocol.

4. The method of claim 2, wherein the GPRS module and wireless network 802.11 protocol module are interactively controlled by one another.
